(19) United States
(12) Patent Application Publication
(10) Pub. No.: US 2008/0228324 A1
(43) Pub. Date: Sep. 18, 2008

(54) Control system of no-fuse breaker using power frequency carrier

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD, Taipei City (TW)

(21) Appl. No.: 11/723,203

(22) Filed: Mar. 16, 2007

(51) Int. Cl. G05D 3/12

(52) U.S. Cl. 700/286

(57) ABSTRACT

A system uses power frequency carrier to control no-fuse breaker. In the system, a controller has a power frequency carrier device. And an other power frequency carrier device is connected with the no-fuse breaker. The two power frequency carrier devices are connected through an indoor power line. The power frequency carrier is sent along the indoor power line so that the controller can remotely control the no-fuse breaker.

### FIELD OF THE INVENTION

The present invention relates to a control system; more particularly, relates to connecting a first power frequency carrier device and a second power frequency carrier device through an indoor power line to remotely control a no-fuse breaker (NFB).

### DESCRIPTION OF THE RELATED ART

A general no-fuse breaker (NFB) is often used for electronic utilities in our environment. On using it, an end of a wire is connected with the NFB, and another end is connected with a socket or a switch. Thus, an electronic utility obtains an outside power from the NFB through the socket or the switch for operation. When a short circuit, an over voltage or an over current happens to the electronic utility, the NFB is released to block the transference of the outside power for safety.

Although the above NFB is released for safety to block from transferring outside power on the short circuit, the over voltage or the over current, the NFB can only be reset from within the room after the NFB is released and it is not possible to reset the NFB remotely (such as a control room or a guard room). Hence, when a house owner is out for a long time or family members are all left, the NFB becomes impossible to reset and this becomes a troublesome situation. Besides, after the NFB is installed, the family members would pay no attention to the NFB. Therefore, the NFB may malfunctioned without caring for a long time. Once an abnormal situation happens to an electric power source or an electronic utility, a serious danger may occur because of the malfunction of the NFB. Hence, the prior art does not fulfill users' requests on actual use.

### SUMMARY OF THE INVENTION

The main purpose of the present invention is to connect a first power frequency carrier device and a second power frequency carrier device through an indoor power line to remotely control an NFB.

To achieve the above purpose, the present invention is a control system of no-fuse breaker using power frequency carrier, comprising at least one NFB comprising a handling device and a first power frequency carrier device; and a remote control device having a monitoring-and-controlling device, where the monitoring-and-controlling device is connected with a display device and a second power frequency carrier device; and the second power frequency carrier device is connected with the first power frequency carrier device through an indoor power line. Accordingly, a novel control system of no-fuse breaker using power frequency carrier is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 to FIG. 2 are the first block view and the second block view showing the preferred embodiment according to the present invention;

FIG. 3 is a view showing the first power frequency carrier device and the second power frequency carrier device;

FIG. 4 is a view showing the state of use; and

FIG. 5 is the third block view.

### DESCRIPTION OF THE PREFERRED EMBODIMENT

The following description of the preferred embodiment is provided to understand the features and the structures of the present invention.

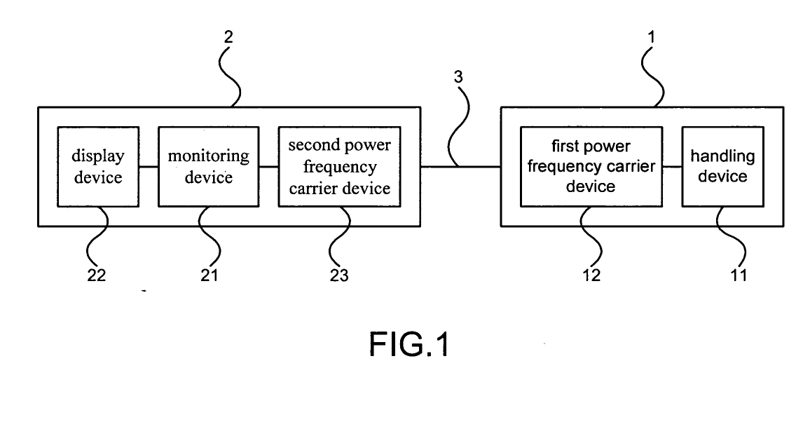

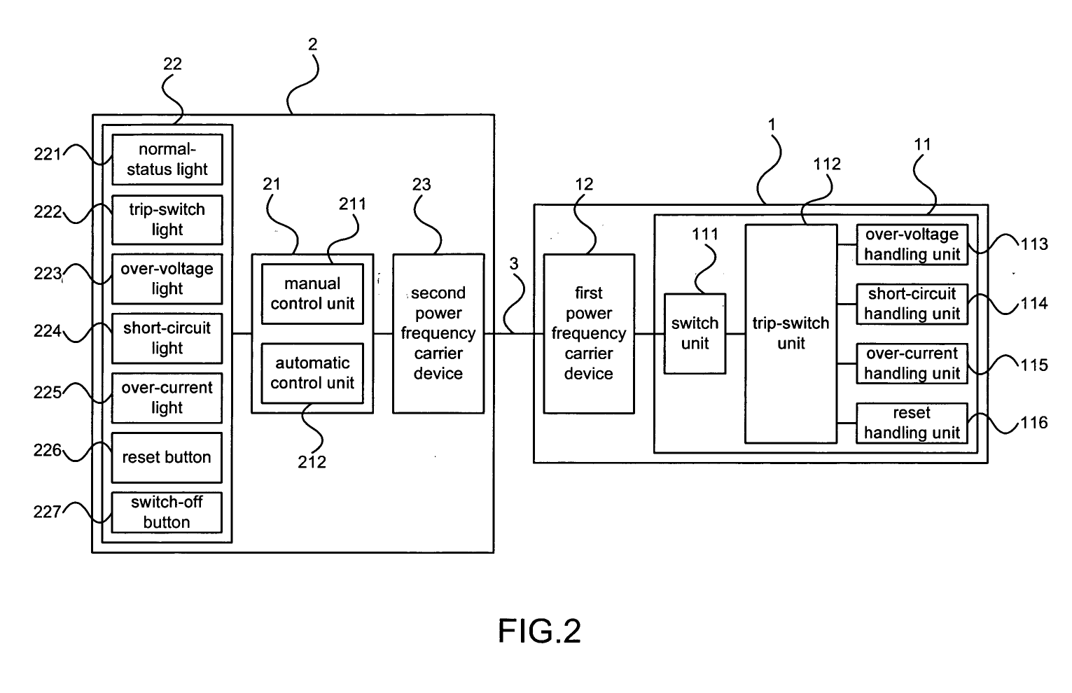

Please refer to FIG. 1 and FIG. 2, which are a first block view and a second block view showing the preferred embodiment according to the present invention. As shown in the figures, the present invention is a control system of no-fuse breaker using power frequency carrier comprising at least one no-fuse breaker (NFB) 1 and a remote control device 2.

The NFB 1 comprises a handling device 11 and a first power frequency carrier device 12. The handling device 11 comprises a switching unit 111, a trip-switch unit 112, an over-voltage handling unit 113, a short-circuit hand ling unit 114, an over-current handling unit 115 and a reset handling unit. The switching unit 111 is connected with the trip-switch unit 112. And, the trip-switch unit 112 is connected with the over-voltage handling unit 113, the short-circuit handling unit 114, the over-current handling unit 115 and the reset handling unit 116.

The remote control device 2 has a monitoring-and-controlling device 21. The monitoring-and-controlling device 21 comprises a manual control unit 211 and an automatic control unit 212. The monitoring-and-controlling device 21 is connected with a display device 22 and a second power frequency carrier device 23. The display device 22 comprises a normal status light 221, a trip-switch light 222, an over-voltage light 223, a short-circuit light 224, an over-current light 225, a reset button 226 and a switch-off button 227. And, the second power frequency carrier device 23 is connected with the first power frequency carrier device 12 through an indoor power line 3. Thus, with the above structure, a novel control system of no-fuse breaker using power frequency carrier is obtained.

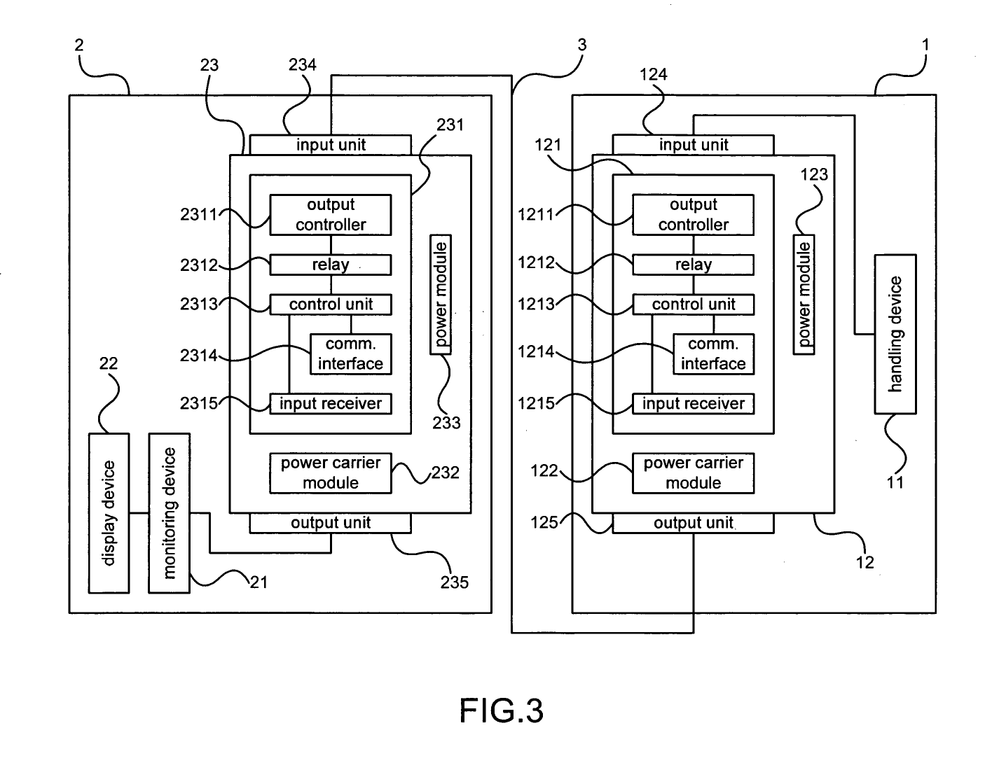

Please refer to FIG. 3, which is a view showing a first power frequency carrier device and a second power frequency carrier device. As shown in the figure, the first power frequency carrier device 12 comprises a single-chip control module 121; a power carrier module 122 having a transferring rate of 1200 bits per second (BPS); a power module 123 providing power for the single-chip control module 121 and the power carrier module; an input unit 124 and an output unit 125. Therein, the single-chip control module 121 comprises an output controller 1211, a relay 1212, a control unit 1213, a communication interface 1214 and an input receiver 1215.

The second power frequency carrier device 23 comprises a single-chip control module 231; a power carrier module 232 having a transferring rate of 1200 BPS; a power module 233 providing power for the single-chip control module 231 and the power carrier module; an input unit 234 and an output unit 235. Therein, the single-chip control module 231 comprises an output controller 2311, a relay 2312, a control unit 2313, a communication interface 2314 and an input receiver 2315.

The control units 1213, 2313 of the first and the second power frequency carrier devices 12, 23 are each a 8051 single-chip processor having an excellent inner structure with a working frequency up to 16 MHz and having a 4 k size of electrically programmable and erasable ROM (Read Only Memory) with eight input pins and eight output pins. The relay 1212, 2312 is located at the output pins to quarantine the circuit for securing and ensuring the operation of the single-chip control module 121, 231. The 8051 single chip has the full-duplex communication interface 1214, 2314 inside. The communication interface 1214, 2314 is an RS232 interface to transfer and receive data to and from outside simultaneously.

Be ca use the operational signals are on a TTL (transistor-transistor-logic) level (with 0 voltage of logic 0 and +5 voltage of logic 1) and the communication interface 1214, 2314 is a serial communication interface transferring or receiving data in a form of bit series, linkages are easily established between controllers (such as an absorbing carrier, an auto-detecting device, etc.), apparatuses and computers.

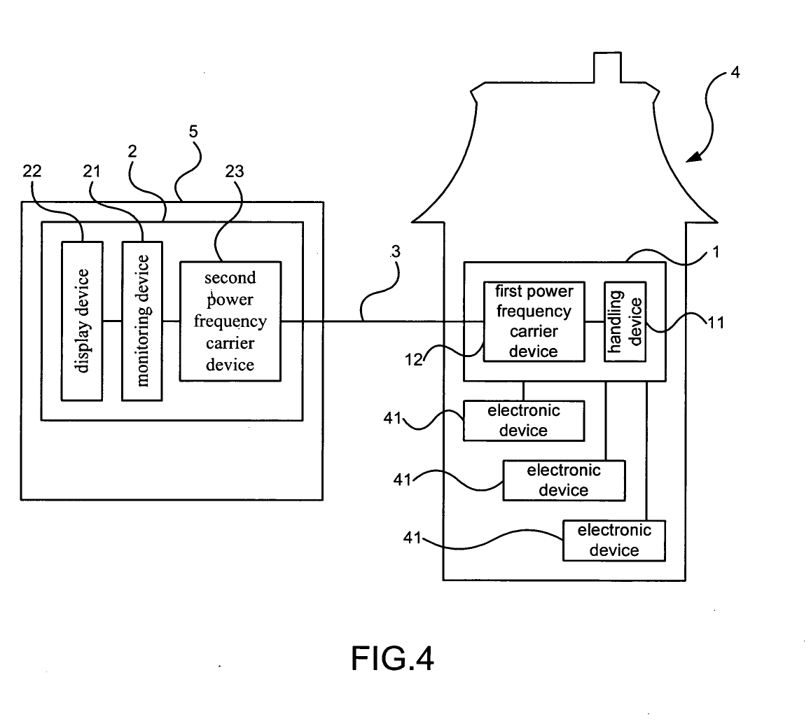

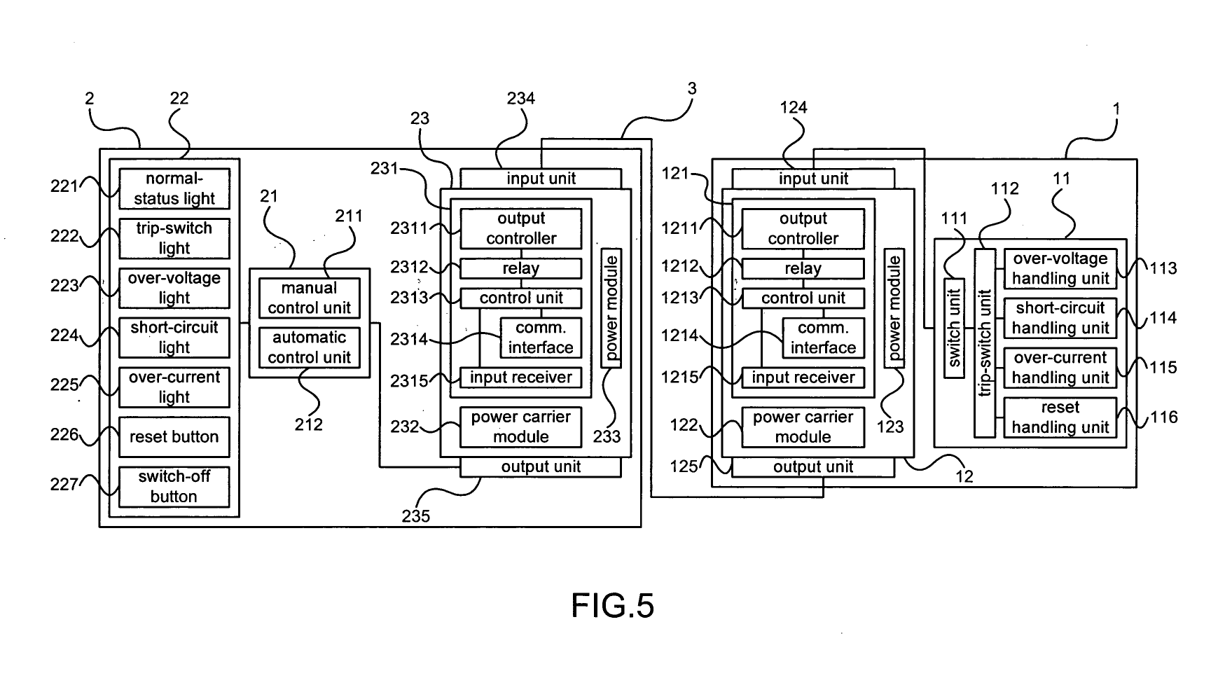

Please refer to FIG. 4 and FIG. 5, which are a view showing a state of use and a third block view. As shown in the figures, when using the present invention, an NFB 1 is deposed in a building 4 or in a main switch case of a local are a; and the NFB 1 is connected with electronic utilities 41 to supply power through the NFB 1 for operation. A remote control device 2 is located in a control room 5 (or a guard room) of a community. The remote control device 2 is plugged in with an indoor power line 3 through a second power frequency carrier device 23 to be connected with a first power frequency carrier device 12. On using an electronic utility, the NFB 1 sends a status signal of the electronic utility 41 from the first power frequency carrier device 12 to the second power frequency carrier device 23 through the indoor power line 3 to be shown on a display device 22. On sending the status signal of the electronic utility 41, the signal from the first power frequency carrier device 12 is integrated through a single-chip control module 121, a power carrier module 1222 and a power module 123 to be coded. A transmission mode and a transmission speed are detected and setup by the single-chip control module 121 to transfer the signal through the indoor power line 3 from an output unit 125 of the first power frequency carrier device 12. Then, the signal is received by an input unit 234 of the second power frequency carrier device 23 to be decoded and de-integrated by a single-chip control module 231, a power carrier module 232 and a power module 233 of the second power frequency carrier device 23. The status of the electronic utility 41 is then recognized by using the signal and the status is outputted by the output unit 235 to be shown by the display device 22

On monitoring the status of the electronic utility 41, a manual control unit 211 and an automatic control unit 212 of a monitoring-and-controlling device 21 are turned on. An over-voltage handling unit 113, a short-circuit handling unit 114 an over-current handling unit 115 and a reset handling unit 116 output no abnormal signal when the electronic utility 41 is operated in a normal status. Hence, the first power frequency carrier device 12 sends a normal signal to the second power frequency carrier device 23 to light on a normal-status light 221 of the display device 22 so that a guard is aware of a normal operation of the electronic utility 41.

On the contrary, the over-voltage handing unit 113, the short-circuit handling unit 114, the over-current handling unit 115 or a trip-switch unit 112 outputs an abnormal signal for the electronic utility 41 when the electronic utility 41 is operated in an abnormal status. The abnormal signal is then sent from the first power frequency carrier device 12 to the second power frequency carrier device 23 so that, according to the abnormal signal received, a corresponding light among a trip-switch light 222, an over-voltage light 223, a short-circuit light 224 or an over-current light of the display device 22 is simultaneously or serially lighted on and a guard is aware of an abnormal operation of the electronic utility 41. Consequently, the guard is able to immediately handle the abnormal operation of the electronic utility 41 remotely by a reset button 226 or a switch-off button 227.

To sum up the present invention is a control system of no-fuse breaker using power frequency carrier, where a first power frequency carrier device and a second power frequency carrier device are connected through an indoor power line to remotely control an NFB.

The preferred embodiment herein disclosed is not in t, ended to unnecessarily limit the scope of the invention. Therefore, simple modifications or variations belonging to the equivalent of the scope of the claims and the instructions disclosed herein for a patent are all within the scope of the present invention.

What is claimed is:

1. A control system of no-fuse breaker using power frequency carrier, comprising:
at least one no-fuse breaker (NFB), said NFB comprising a handling device and a first power frequency carrier device; and
a remote control device, said remote control device having a monitoring-and -controlling device, said monitoring-and-controlling device being connected with a display device and a second power frequency carrier device, said second power frequency carrier device connecting to said first power frequency carrier device through an indoor power line.

2. The control system according to claim 1,
wherein said handling device comprises a switching unit, a trip-switch unit, an over-voltage hand ling unit, a short-circuit handling unit, a over-current handling unit and are set handling unit, said trip-switch unit connecting to said switching unit, said trip-switch unit connecting to said over-voltage handling unit, said short-circuit handling unit, said over-current handling unit and said reset handling unit.

3. The control system according to claim 1,
wherein said monitoring-and-controlling device comprises a manual control unit and an automatic control unit.

4. The control system according to claim 1,
wherein said display device comprises a normal-status light, a trip-switch light, an over-voltage light, a short-circuit light, a over-current light, a reset button and a switch-off button.

5. The control system according to claim 1,
wherein each of said first power frequency carrier device and said second power frequency carrier device comprises a single-chip control module, a power carrier module, a power module, an output controller and an input receiver.

6. The control system according to claim 5,
wherein said single-chip control module comprises an input unit, an output unit, a control unit, a communication interface and a relay.

7. The control system according to claim 6,
wherein said control unit is a 8051 single chip.

8. The control system according to claim 6,
wherein said control unit has a working frequency of 16 megahertz.

9. The control system according to claim 6,
wherein said communication interface is an RS232 interface.

10. The control system according to claim 5,
wherein said power carrier module has a transferring rate of 1200 bits per second.
